(19) United States
(12) Patent Application Publication
(10) Pub. No.: US 2006/0007882 A1
(43) Pub. Date: Jan. 12, 2006

(54) System and method for selecting stable routes in wireless networks

(75) Inventors: Surong Zeng, Altamonte Springs, FL (US); Sebnem Z. Ozer, Altamonte Springs, FL (US)

Correspondence Address: GARDNER CARTON & DOUGLAS LLP;(MESHNETWORKS/MOTOROLA) ATTN: PATENT DOCKET DEPT., 191 NORTH WACKER DRIVE, SUITE 3700, CHICAGO, IL, 60606-1698, US

(73) Assignee: MESHNETWORKS, INC., Maitland, FL (US)

(21) Appl. No.: 11/176,786

(22) Filed: Jul. 7, 2005

Related U.S. Application Data
(60) Provisional application No. 60/585,954, filed on Jul. 7, 2004.

(51) Int. Cl. H04Q 7/00

(52) U.S. Cl. 370/328

(57) ABSTRACT

A system and method for selecting a route from multiple potential routes in wireless network is shown. The present invention sends multiple route requests with the same route request identifier value concurrently to multiple candidate routes to obtain accurate bi-directional route metrics for candidate routes. The route having the best route metrics among the candidate routes is selected as the new route for communication through the wireless network.

This application claims the benefit of U.S. Provisional Application No. 60/585,954, filed Jul. 7, 2004, the entire content being incorporated herein by reference.

### BACKGROUND OF THE INVENTION

1. Field of the Invention

The present invention relates route selection in wireless networks and, more particularly, to route selection in ad-hoc multi-hopping peer-to-peer wireless networks.

2. Description of the Related Art

In recent years, a type of mobile communications network known as an “ad-hoc” network has been developed. In this type of network, each mobile node is capable of operating as a base station or router for the other mobile nodes, thus eliminating the need for a fixed infrastructure of base stations. Details of an ad-hoc network are set forth in U.S. Pat. No. 5,943,322 to Mayor, the entire content of which is incorporated herein by reference. As can be appreciated by one skilled in the art, network nodes transmit and receive data packet communications in a multiplexed format, such as time-division multiple access (TDMA) format, code-division multiple access (CDMA) format, or frequency-division multiple access (FDMA) format, which enables a single transceiver at a first node to communicate simultaneously with several other nodes in its coverage area.

More sophisticated ad-hoc networks are also being developed which, in addition to enabling mobile nodes to communicate with each other as in a conventional ad-hoc network, further enable the mobile nodes to access a fixed network and thus communicate with other mobile nodes, such as those on the public switched telephone network (PSTN), and on other networks such as the Internet. Details of these advanced types of ad-hoc networks are described in U.S. patent application Ser. No. 09/897,790 entitled “Ad Hoc Peer-to-Peer Mobile Radio Access System Interfaced to the PSTN and Cellular Networks”, filed on Jun. 29, 2001, in U.S. patent application Ser. No. 09/815,157 entitled “Time Division Protocol for an Ad-Hoc, Peer-to-Peer Radio Network Having Coordinating Channel Access to Shared Parallel Data Channels with Separate Reservation Channel”, filed on Mar. 22, 2001, and in U.S. patent application Ser. No. 09/815,164 entitled “Prioritized-Routing for an Ad-Hoc, Peer-to-Peer, Mobile Radio Access System”, filed on Mar. 22, 2001, the entire content of each being incorporated herein by reference.

The capacity of certain wireless networks, such as pure multi-hop wireless ad hoc networks, diminishes as the number of nodes increases in the network, as described in a publication by Piyush Gupta and P. R. Kumar entitled “The Capacity of Wireless Networks”, IEEE Transactions on Information Theory, pp. 388-404, Vol. 46, No. 2, March 2000, herein incorporated by reference in its entirety. In order to increase the capacity of multi-hop wireless Ad Hoc networks, fixed infrastructure nodes may be introduced into the network as described in a publication by Matthew J. Miller, William D. List and Nitin H. Vaidya entitled “A Hybrid Network Implementation to Extend Infrastructure Reach”, UIUC Technical Report, January 2003, herein incorporated in their entirety. In this kind of hybrid multi-hop wireless Ad Hoc networks, in order to reduce the route discovery latency, a hybrid routing protocol and network management techniques can be used as described in a U.S. patent application by Avinash Joshi entitled “System and Method For Achieving Continuous Connectivity to an Access Point or Gateway in a Wireless Network Following an On-demand Routing Protocol and to Perform Smooth Handoff of Mobile Terminals between Fixed Terminals in the Network,” Ser. No. 10/755,346 filed Jan. 13, 2004, published U.S. Patent Application No. 2004/0143842, herein incorporated by reference in its entirety.

The essence of hybrid routing and network management protocols is, for each device in the network, to maintain a route to the access point (AP) proactively and discover other routes reactively. During the network operation, each device periodically refreshes the route and registration to the AP. All devices broadcast their own associated APs and the route metrics to the APs in Hello type of advertisement messages. The route metrics can be number of hops, link reliability and data rate along the route, or a combination of those factors. If a device hears an AP to which it has better route metrics than to the one that it is currently associated with, or it hears a new route to the same AP but with better route metrics than the current one that it is using to reach the current associated AP, it will start a handoff process to switch route. The handoff process is started with unicasting route request to the chosen AP candidate through the new route.

A device can sometimes hear multiple possible new routes with similar route metrics to AP(s) from different neighbors. It can only randomly choose one candidate to try to set up a new route if multipath routing is not used or choose one candidate to set up a new route as one of the active routes if multipath routing is used. However, due to the differences in radio transceiver capabilities and perceived interference levels of nodes, asymmetric links are very common in mobile wireless networks. The route metrics that the device receives from its neighbors may not accurately represent the performance for bi-directional data communication over the route. There may be asymmetric links along the route. Over these asymmetric links, one direction has high packet completion rate, but another direction has very low packet completion rate. Only when there are data exchanged over those links can the asymmetric link quality be detected. In addition, although the data loss may be severe in one direction, small messages (e.g. control and reservation messages including request-to-send (RTS), clear-to-send (CTS), Hello message, route request, route reply, etc.) can still be exchanged successfully with high probability. The success of exchanging short route request and route reply messages over asymmetric links leads to setting up an asymmetric route based on route metrics for these short messages. Once the asymmetric route is used for data communication, the data loss rate may be very high, which can lead to a new handoff process. The frequent handoff processes generate persistent oscillation in the network, which may significantly degrade the network performance. A method to blacklist a node through which a route discovery process failed is described in RFC 3561 and in a publication by Charles E. Perkins, Elizabeth M. Belding-Royer and Samir R. Das entitled “Ad hoc On-Demand Distance Vector (AODV) Routing”, IETF draft January, 2002, both documents being incorporated by reference herein in their entirety. This solution is useful when the absolute unidirectional links are present, but is not useful for asymmetric links where small packets still have acceptable completion rates.

### BRIEF DESCRIPTION OF THE DRAWINGS

These and other objects, advantages and novel features of the invention will be more readily appreciated from the following detailed description when read in conjunction with the accompanying drawings, in which:

FIG. 1 is a block diagram of an example ad-hoc wireless communications network including a plurality of nodes employing a system and method in accordance with an embodiment of the present invention;

FIG. 2 is a block diagram illustrating an example of a mobile node employed in the network shown in FIG. 1;

FIG. 3 is a conceptual block diagram of an example of the relationship between wireless routers and access points of the network shown in FIG. 1;

FIG. 4 is a conceptual block diagram illustrating message traffic between a subscriber device and an access point in one example scenario in accordance with an embodiment of the present invention;

FIG. 5 is a flow control diagram illustrating an embodiment of a process taking place in a subscriber device in accordance with one aspect of the present invention; and

FIG. 6 is a flow control diagram illustrating an embodiment of a process taking place in an access point in accordance with one aspect of the present invention.

### DETAILED DESCRIPTION OF THE PREFERRED EMBODIMENTS

As described in detail below, the present invention relates to a system and method for selecting a route in a wireless network during a route set-up period by detecting and comparing actual bi-directional route metrics of candidate routes to avoid route oscillation. In particular, the present invention addresses a problem related to asymmetric routes, wherein the perceived route metrics do not reflect the actual bi-directional route metrics for routes. The problem leads to route oscillation in the network and introduces increased latency in discovering a route that is adequate for communications. The present invention thus provides a mechanism to confirm the potential route candidates and current used route simultaneously. This method reduces the latency in discovering a satisfactory route and avoids persistent route oscillation in wireless networks.

A system and method according to an embodiment of the present invention is thus capable of selecting a route from a subscriber device to an access point through a wireless network. The access point is configured to respond to receiving a first route request message having a particular route request identifier value by sending a first route response message to a source of the first route request message with bi-directional route metrics from the first route request message. The access point is adapted to respond to any subsequent route request message with the particular route request identifier value by sending another route response message with bi-directional route metrics from the subsequent route request message only if the route metrics from the subsequent route request message are better than the route metrics from the first route request message.

This embodiment also includes a subscriber device configured to unicast a route request message along a first route to the access point, where the first route request message is directed toward the access point and includes a first route request identifier value. The subscriber device is also configured to unicast a second route request message along a second route to the access point, where the second route request message is directed toward the access point and includes the first route request identifier value. Each route request collects the latest route metrics along each route on the way that it traverses to the access point. The end-to-end route metrics are passed to the access point which makes acceptance decision according to the route metrics. Finally, the subscriber device is further configured to receive route response messages from the access point and, based on the bi-directional route metrics included in the route response messages, select the second route for communication with the access point if the route metrics for the second route are better than the route metrics for the first route.

In accordance with another embodiment of the present invention, a subscriber device in a wireless network is configured to unicast multiple route request messages over multiple potential routes to the access point in order to detect the actual end-to-end route metrics for each route, where all of the multiple route request messages include an identical route request identifier value. Each route request detects and collects the latest route metrics along each route. The end-to-end route metrics are passed to the access point. The access point is configured to respond the first route request, and also respond to subsequent route request if the subsequent route request carries better end-to-end route metrics. The subscriber device is also configured to receive route response messages corresponding to the multiple route request messages, where the route response messages include actual end-to-end route metrics for the corresponding route. One of the multiple route candidates is selected for communication with the access point based on the actual end-to-end route metrics received with the route response messages.

More particularly, the subscriber device is configured to send multiple unicast route requests over candidate routes to the access point. Each route request carries the same route request identifier value. Along each candidate route, all the devices are configured to exchange the link condition between each sender and receiver via exchanging the unicast message, thus the actual bi-directional link condition can be detected. The route request accumulates the route metrics reflecting the link conditions between each sender and receiver along the route. The access point is configured to respond to the route request by unicasting a route response with the route request identifier value and the route metrics. Each route response message continues to accumulate route metrics along the route back to the subscriber device. The subscriber device is configured to receive multiple route response messages from the access point, where the route metrics included in each route response are bi-directional route metrics that reflect the latest route metrics in both directions between the subscriber device and the access point. The subscriber device is further configured to select a route having better bi-directional route metrics than another route. For example, if the subscriber device is using a current route to the access point and a new route has better bi-directional route metrics than the bi-directional route metrics for the current route, then the subscriber device will switch to using the new route. However, if the bi-directional route metrics for the new route are not better than the bi-direction metrics for the current route, then the subscriber device will continue to use the current route to the access point.

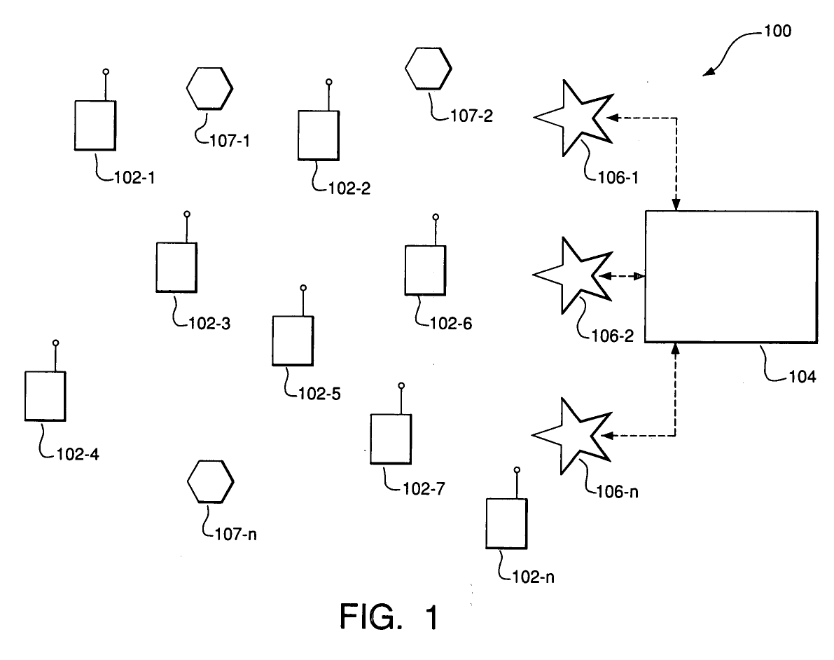

FIG. 1 is a block diagram illustrating an example of an ad-hoc packet-switched wireless communications network 100 suitable for use with the present invention. Specifically, the network 100 includes a plurality of mobile wireless user terminals 102-1 through 102-n (referred to generally as nodes 102 or mobile nodes 102), and can, but is not required to, include a fixed network 104 having a plurality of access points 106-1, 106-2, 106-n (referred to generally as nodes 106 or access points 106), for providing nodes 102 with access to the fixed network 104. The fixed network 104 can include, for example, a core local access network (LAN), and a plurality of servers and gateway routers to provide network nodes with access to other networks, such as other ad-hoc networks, the public switched telephone network (PSTN) and the Internet. The network 100 further can include a plurality of fixed routers 107-1 through 107-n (referred to generally as nodes 107 or fixed routers 107) for routing data packets between other nodes 102, 106 or 107. It is noted that for purposes of this discussion, the nodes discussed above can be collectively referred to as “nodes 102, 106 and 107”, or simply “nodes”.

As can be appreciated by one skilled in the art, the nodes 102, 106 and 107 are capable of communicating with each other directly, or via one or more other nodes 102, 106 or 107 operating as a router or routers for packets being sent between nodes, as described in U.S. patent application Ser. Nos. 09/897,790, 09/815,157 and 09/815,164, referenced above.

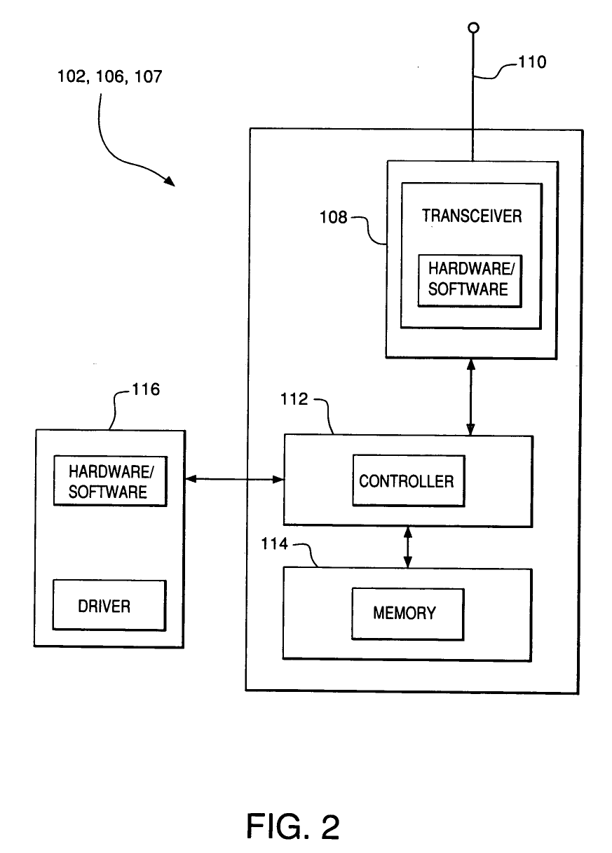

As shown in FIG. 2, each node 102, 106 and 107 includes a transceiver, or modem 108, which is coupled to an antenna 110 and is capable of receiving and transmitting signals, such as packetized signals, to and from the node 102, 106 or 107, under the control of a controller 112. The packetized data signals can include, for example, voice, data or multimedia information, and packetized control signals, including node update information.

Each node 102, 106 and 107 further includes a memory 114, such as a random access memory (RAM) that is capable of storing, among other things, routing information pertaining to itself and other nodes in the network 100. As further shown in FIG. 2, certain nodes, especially mobile nodes 102, can include a host 116 which may consist of any number of devices, such as a notebook computer terminal, mobile telephone unit, mobile data unit, or any other suitable device. Each node 102, 106 and 107 also includes the appropriate hardware and software to perform Internet Protocol (IP) and Address Resolution Protocol (ARP), the purposes of which can be readily appreciated by one skilled in the art. The appropriate hardware and software to perform transmission control protocol (TCP) and user datagram protocol (UDP) may also be included.

As further shown in FIG. 2, certain nodes, especially mobile nodes 102, can include a host 116 which may consist of any number of devices, such as a notebook computer terminal, mobile telephone unit, mobile data unit, or any other suitable device. Each node 102, 106 and 107 also includes the appropriate hardware and software to perform Internet Protocol (IP) and Address Resolution Protocol (ARP), the purposes of which can be readily appreciated by one skilled in the art. The appropriate hardware and software to perform transmission control protocol (TCP) and user datagram protocol (UDP) may also be included.

As can be appreciated from the above, in the network 100, an Internet Access Point (AP) 106 is the point of attachment of the wireless part and the wired Internet. If a Subscriber Device (SD) 102 is not in direct communication range with an AP 106, the DS 102 depends upon other devices to reach the AP 106. These devices can be other SDs 102 or Wireless Routers (WR) 107 which are deployed specifically to provide coverage to these SDs.

In a wireless network, such as network 100, all nodes need to maintain continuous connectivity with the AP as most of the traffic is to and from an AP. This is true for both the field deployment and deployment in an office environment. Continuous connectivity is also needed to tunnel the dynamic host configuration protocol (DHCP) and address resolution protocol (ARP) IP broadcast to the AP. If an on-demand protocol, such as the Ad Hoc On-Demand Distance Vector Routing protocol (AODV), is used in an ad-hoc network, no routes are maintained proactively. Accordingly, as discussed in the Background section above, a hybrid mesh routing protocol was proposed to provide routes to APs that may be maintained at all times with relatively low overhead in published U.S. Patent Application No. 2004/0143842 referenced above.

As can be appreciated by one skilled in the art, an on-demand routing protocol (for example AODV) creates routes only when desired by the source node. Hence, when a node requires a route to a destination, the node initiates a route discovery process within the network 100. The route discovery process may flood the routing packets in a limited area or may even flood the whole network. This process has the potential for high latency and large routing overhead to set up a route. The commonly employed approach, referred to as an Expanding Ring Search, can increase the average latency of route discovery, as multiple discovery attempts and time-outs may be needed before a route to the target node is found, the high latency will require the source node to buffer the packets which may be difficult for memory constrained nodes in such a kind of network resulting in packet loss. Furthermore, this elongated route discovery process also increases the overhead as each discovery can lead to a network wide flood.

Since most traffic in this kind of network flows between an AP and other nodes, such as WRs and SDs, these floods can be avoided if the nodes proactively maintain routes to the AP. This will also avoid the latency and buffering of packets involved in finding route to an AP. AODV also assumes bi-directional links among nodes, which can lead to incorrect routes. The routing protocol proposed in published U.S. Patent Application No. 2004/0143842 uses a unicast route request to confirm the bi-directional links. However, this hybrid routing protocol can not detect asymmetric links before initiating any route setup process as it is shown in the following example. The asymmetric links lead to the route oscillation in the network and degrade the network performance. The technique according to the embodiments of the invention described herein selects a route among multiple potential routes to and from the AP by detecting and comparing the actual end-to-end path conditions between a subscriber device and an AP.

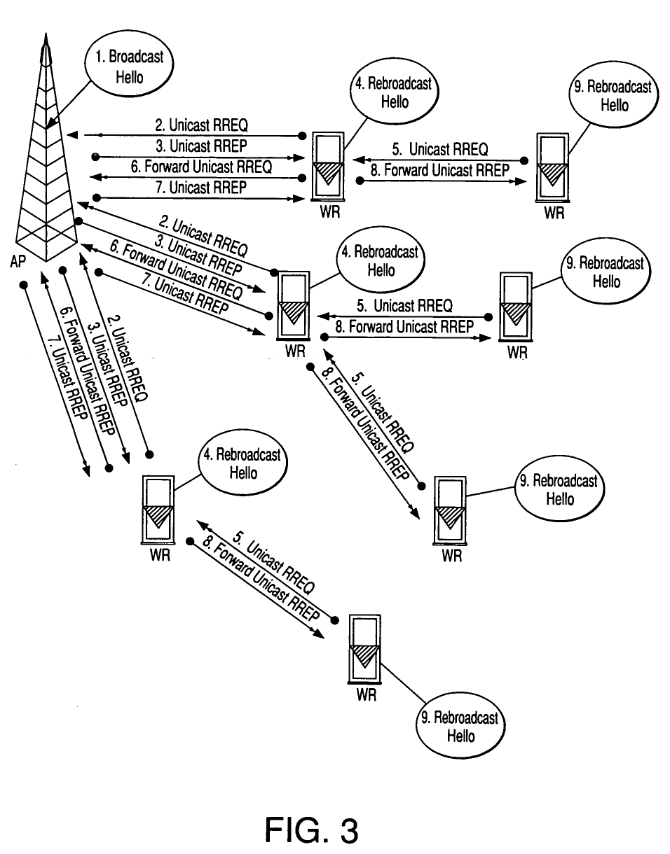

An example of the process the hybrid routing protocol proposed in published U.S. Patent Application No. 2004/0143842 will now be described with reference to FIG. 3. All the nodes will periodically broadcast “Hello Message” which is generally sent by all nodes in such network to maintain connectivity as described, for example, in a U.S. Provisional Patent Application entitled “System and Method to Maximize Channel Utilization in a Multi-Channel Wireless Communication Network”, Ser. No. 60/475,882, filed on Jun. 5, 2003, the entire contents of which being incorporated herein by reference.

The contents of the Hello message can be any combination of the following fields:
Type of node: This will let other nodes know about the type of the device which can help them decide whether or not this node should be used to route packets. This field can also help in deciding the routing metrics as described in U.S. Provisional Patent Application of Avinash Joshi entitled “System and Method to Improve the Network Performance of a Wireless Communication Network by Finding an Optimal Route Between a Source and a Destination”, Ser. No. 60/476,237, filed on Jun. 6, 2003, the entire contents of which are incorporated herein by reference.
Number of hops from the associated AP.
Address of the node (IP or MAC address or both): This decision is based on whether the network uses layer 2 routing or layer 3 routing or a combination of both.
Address of the associated AP (IP or MAC address or both): This decision is based on whether the network uses layer 2 routing or layer 3 routing or a combination of both.
Routing Metrics to the associated AP: This field helps in deciding one route versus another as described, for example, in U.S. Provisional Patent Application Ser. No. 60/476,237 referenced above, and in a U.S. Patent Application of Eric A. Whitehill, et al. entitled “Embedded Routing Algorithms Under the Internet Protocol Routing Layer of a Software Architecture Protocol Stack”, Ser. No. 10/157,979, filed on May 31, 2002, the entire contents of which are incorporated herein by reference.
Other Metrics (for example some metrics representing the load on the AP like number of active users associated with the AP or total bandwidth used by the users): this field can be used to do load balancing across multiple APs and achieve quality of service (QoS) goals across multiple APs.
QoS metrics: Used for QoS Routing.
Address of the node that is being used as next hop towards the AP.
Broadcast ID: a broadcast ID similar to that used in the AODV route request (RREQ) process, which is helpful in detecting duplicate packets and dropping those duplicates. This broadcast ID may not be required if some sequence number is already a part of MAC header to discard duplicate packets.
Power Level: This message can either be sent at some fixed power that is known throughout the network, or power used should be indicated in this field of the packet. This will help the node receiving the packet to know the path loss between the transmitter and itself.
TTL: The packet can also have a (time-to-live) TTL value set to NETWORK_DIAMETER, which depends upon the size of the network 100 and the maximum number of hops possible between an AP and a node associated with that AP. The TTL value can then be decremented by each protocol interface layer (PIL) daemon as the packet propagates throughout the network 100, which can control the maximum number of hops possible between an AP and any other node in the network.
A node can also send similar information about some other AP/APs with which it is not associated. The information can include all the metrics mentioned above.

In the hybrid routing protocol described in published U.S. Patent Application No. 2004/0143842, an AP builds a Hello packet containing data pertaining to an IP/MAC address of the AP. The routing metrics to the associated AP is set to 0 as it is itself an AP. AP broadcasts the Hello packet periodically.

The WRs and SDs listens for a Hello packet containing data pertaining to an IP/MAC address of an AP, a number of hops from the forwarding node, different metrics, and so on, as mentioned above. If the node decides to use the sender as the next hop towards the AP, it issues a RREQ for the AP with a D bit set to the forwarding node.

If a RREP is received, the route to AP is set up, and the node starts to broadcast Hello packet to indicate its routing metrics to the AP. This example shows that the route selection decision is solely based on the view from Hello messages' receiver side. However, wireless links are prone to be asymmetric due to the difference of the environment around the sender and the receiver, difference of the devices, etc. The route selection may be wrong if based on only one side. In this kind of routing, only when the RREP comes back from the reverse route, the real bi-directional routing metrics can be found. Following the rule in AODV and in published U.S. Patent Application No. 2004/0143842, the latest RREQ and RREP always carry the newest routing identifier <destination sequence number, request ID>. Therefore, even the new route is worse than the existing one, it would override the existing one. The source node of the RREQ has to initiate another route setup process to switch back to the old route, or try other potentially good candidate routes. It may lead to the route oscillation and latency to set up a stable route to the AP. The technique according to the embodiments of the invention described herein reduces the probability to select a route which consists of asymmetric links while finding routes from nodes to the AP, and vice-versa.

The present invention sends multiple route requests RREQs having the same routing identifier value concurrently to multiple candidate routes. Sending multiple RREQs with the same routing identifier permits the routing metrics for different routes corresponding to the RREQs to be obtained so that the routes may be compared. The current route may also be included in the candidate routes so that the current route can be compared to other possible routes. The present invention obtains latest bi-directional route metrics for candidate routes and may select a route with better route metrics as the new route. Although the algorithm will be explained for the AODV based hybrid routing protocol proposed in published U.S. Patent Application No. 2004/0143842, the algorithm can be extended to other types of hybrid routing protocols.

In the hybrid routing protocol, each route request carries destination sequence number to avoid loop and unique request ID to avoid duplicate route request. The forwarding nodes only forward the first route request with one request ID, and discard others with the same request ID. The destination node will accept the first route request with fresh enough destination sequence number, and generate a route reply to the source node. When a device perceives a potentially better route to its associated AP from a broadcast Hello message, it will set up a new route to this AP by unicasting a route request for this AP to the neighbor where the Hello message was received from. As explained in the previous section, this new route may not be as good as it is perceived. The route request and route reply exchange process along the route will detect the real bi-directional link quality by exchanging the view of two end points of a link as described in “System and Method for Characterizing the Quality of a Link in a Wireless Network” by Avinash Josh and Guenael Strutt filed Jun. 7, 2004, application Ser. No. 10/863,534 herein incorporated by reference in its entirety. However, because the route reply carries the latest sequence number for the new route, the device will switch to the new route even if the returned real route metrics are worse for the new route than the metrics for the current route to the associated AP.

In one embodiment of the present invention, a source node device issues two unicast route requests to the associated AP concurrently. One route request is to the perceived new route, and other route request is to the current route used by the device. Both route requests have same sequence number and route request ID. Each unicast route request triggers each of the devices on each route to exchange the view of two end points of a link as described in “System and Method for Characterizing the Quality of a Link in a Wireless Network” by Avinash Josh and Guenael Strutt filed Jun. 7, 2004, application Ser. No. 10/863,534. Thus the actual bi-directional link quality is detected for each link on each route. Each unicast route request also accumulates the route metrics along its respective route. All intermediate nodes will not only forward the request with one request ID, when they see the request ID for the first time, but will also forward other requests with same request ID if the other requests carry better route metrics.

The associated AP will answer a route request with a particular request ID when it sees the request ID value for the first time. Subsequently, when the associated AP gets another route request with same request ID, it will generate another route reply if the subsequent route request carries better route metrics than the earlier route request seen by the AP. Otherwise, the AP will ignore the later route requests. Therefore, the source node will get a route reply for the route with the best route metrics. If it gets multiple route replies, the one with better route metrics must have an equal or larger sequence number than the one with worse route metrics. Consequently, the present invention makes these two routes comparable and the source node then can choose the route with the best metrics. After exchanging route request and route reply through the new route, we can confirm the bi-directional route metrics of the new route. By issuing a refreshing route request over the currently used route, we can get the latest route metrics of the current route. If the actual route metrics of the new route are not as good as the route metrics for the current route, then the new route will be rejected. In this way, the present invention provides an approach for selecting a better route to an access point and avoids an unnecessary handoff in the network.

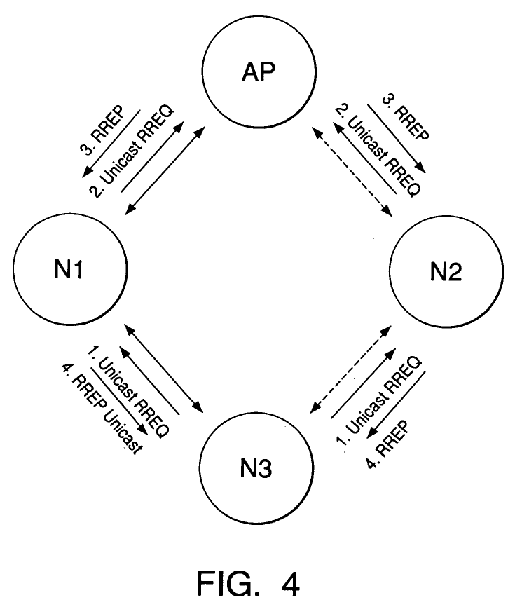

In FIG. 4, an example scenario is illustrated to demonstrate the algorithm in a simple scenario where only two candidates are present. The current route to AP for node N3 consists of solid lines, and a new route consists of dashed lines. Because N3 has never exchanged data with N2, it does not know that the link between them is actually an asymmetric link. Let's assume N3 maintains AP's sequence number x, and AP maintains its own sequence number y, in which y≧x−1. In the original protocol, N3 will issue a unicast route request (RREQ) to node N2 for the new route with sequence number x, and get a route reply (RREP) with the sequence number equal to y if y>x, or x if y<x according to AODV sequence number rules. Although the route request and route reply will trigger N3 and N2 to exchange their view about this link as described U.S. patent application Ser. No. 10/863,534 referenced above, the returned route metrics for the new route to the AP via N2 may appear to be better than the route metrics of the current route, but, due to asymmetry in the link, may actually be worse for data communications. In this case, N3 will switch to the new route because the route reply has a larger sequence number than that for the current route. Subsequent exchange of data between the AP and node N3 via node N2 may result in an unacceptably high failure rate and result in abandonment of the new route and a search for another route.

In the present invention, node N3 issues two unicast route requests with sequence number x (message 1 to node N1 and another message 1 to node N2). One unicast route request (message 1 to node N1) is sent over the currently used route and, in the example shown, is unicast from node N1 to the access point AP (message 2 from N1 to AP). Another unicast route request (message 1 to node N2), is sent over the new route to N2, which forwards the route request to the AP (message 2 from N2 to AP).

If the route request over the route currently used by node N3 reaches the AP before the route request over new proposed route, then the AP will only generate one route reply (message 3′ RREP from AP to node N1 and message 4′ RREP forwarded from N1 to N3) for the request over the currently used route because it will not reply the late route request with worse route metrics than the currently used route.

However, if the route request over the currently used route reaches AP after the route request over the new route, then the AP will generate another route reply for this route request (message 3 RREP from AP to N2 and message 4 from N2 to N3) because it will reply the late route request with better route metrics. In this case, source node N3 will get two route replies with same sequence number. The route with the same sequence number is comparable according to AODV sequence number rules. Therefore, N3 can choose the better of these two route replies. In either case, N3 will not switch to the new route unless its bi-directional route metrics are better than the currently used route, which avoids the oscillation of the route to AP.

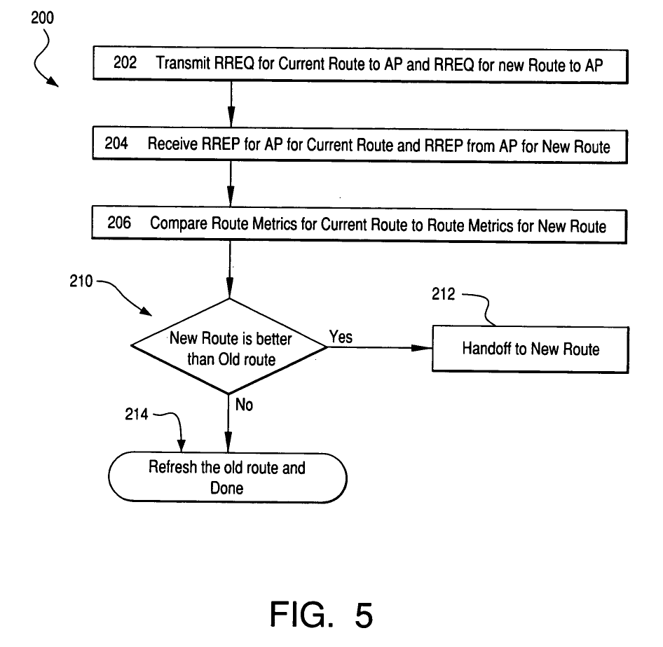

FIG. 5 is a control flow diagram illustrating one embodiment of a process 200 in a subscriber device such as N3 in FIG. 4. As discussed above, at step 202, the SD will transmit a route request RREQ for the currently used route to the AP and another RREQ for a new route to the AP, each with the same route request ID value, which enables them to be compared with one another. The SD will then wait to receive route request replies to the RREQs sent at step 202. At step 204, an RREP from the AP is received with metrics for the currently used route and another RREP from the AP is received with metrics for the new route. Note that, as described above, if the RREQ for the new route is received by the AP after the RREQ for the currently used route, then the AP will not generate a RREP for the new route. Presuming that two RREPs were sent by the AP, at step 206, the route metrics for the current route are compared to the new route. At step 210, if the metrics for the new route are better than the currently used route, then control branches to step 212 where the SD switches to the new route. Otherwise, control flow continues to step 214 and no switch in the route used by the SD takes place. This process may be performed at preset time intervals, in response to the communications metrics for the current route dropping below a preset threshold, or on the basis of other events more suitable to the particular application.

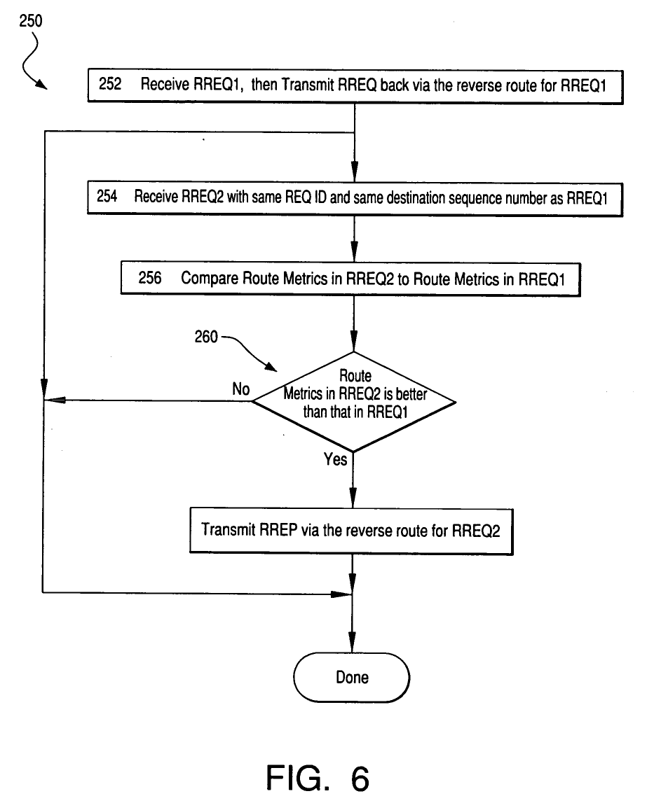

FIG. 6 is a control flow diagram illustrating one embodiment of a process 250 in an access point such as the AP in FIG. 4. As discussed above, at step 252, a first route request RREQ1 is received with a particular route ID value. At step 254, the AP transmits a RREP to the source node with the route metrics pertaining to RREQ1. At step 256, the AP receives a second route request RREQ2 with the same value for the route request ID. The route metrics in RREQ2 are compared to the route metrics for RREQ2 at step 258. If the route request metrics for RREQ2 are better than RREQ1, then control branches to step 262 and the AP transmits an RREP with route metrics for RREQ2 back to the source node. Otherwise, control branches at step 260 back to step 256. While the AP will send a RREP to the first RREQ it receives with a particular value for route request ID, the AP will not send a RREP for a RREQ with the same route request ID value that has poorer route metrics than the previous RREQ with the route request ID value.

The examples illustrated above illustrate a case where two routes are considered—the current used route and the perceived best candidate route. This approach can be extended to a more general scenario in which multiple potential new routes with similar route metrics are perceived by the subscriber device. The SD can send multiple unicast route requests with the same sequence number and same route request ID to all these routes in order to discover the route with the best route metrics or route metrics above a given threshold. In other words, the same request identifier (destination sequence number, route request ID) permits them to be compared for purposes of route selection. By taking this approach, the amount of latency for route selection and route oscillation arising from selecting the wrong route (e.g. due to route asymmetry) may be reduced over the approach where only one route that is perceived as the best route is attempted each time.

The examples described above consider the link quality as the route metrics, and explain in the asymmetric link problem context. The approach does not limit the route metrics to the link quality. The approach can be applied to detect and confirm any other end-to-end route metrics, including but not limited to number of hops, delay, available bandwidth, battery life, congestion metrics, and so on. Thus, the optimum route according to the actual end-to-end route metrics can be selected among multiple candidate route with short latency.

This present invention is directed toward a system and method that can confirm multiple routes simultaneously and provide the source node a chance to choose a superior route among multiple candidates. The present invention may also avoid unnecessary handoff events due to asymmetric route characteristics. It also reduces the latency and route oscillation involved in choosing one route among multiple possible routes that have similar perceived route metrics.

Although only a few exemplary embodiments of the present invention have been described in detail above, those skilled in the art will readily appreciate that many modifications are possible in the exemplary embodiments without materially departing from the novel teachings and advantages of this invention. For example, the order and functionality of the steps shown in the processes may be modified in some respects without departing from the spirit of the present invention. Accordingly, all such modifications are intended to be included within the scope of this invention as defined in the following claims.

What is claimed is:

1. A system for selecting a route through a wireless network, the system comprising:
an access point and at least one subscriber device;
the access point being configured to respond to receipt of a first route request message including a first route request identifier value by sending to a source of the first route request message a first route response message including bi-directional route metrics from the first route request message, and the access point is adapted to respond to a second route request message including the first route request identifier value by sending a second route response message including bi-directional route metrics from the subsequent route request message if the route metrics from the second route request message are better than the route metrics from the first route request message; and
the subscriber device being configured to send along a first route to the access point the first route request message including the first route request identifier value, and the subscriber device is also configured to send the second route request message along a second route to the access point, the second route request including the route request identifier value that is the same as that included in the first route request.

2. The system of claim 1, where each route request detects and collects latest bi-directional route metrics along its way traversing to the access point, and passes the end-to-end route metrics to the access point.

3. The system of claim 1, where the subscriber device is further configured to receive the first and second route response messages from the access point and, based on the bi-directional route metrics included in the route response messages, select the second route for communication with the access point if the route metrics for the second route are better than the route metrics for the first route.

4. The system of claim 1, where the first route corresponds to a route to the access point that is currently being used by the subscriber device and the second route corresponds to a new route to the access point.

5. The system of claim 1, wherein the subscriber device is further configured to unicast the first and second route request messages as well as multiple other route request messages to request multiple potential new routes to the access point.

6. The system of claim 5, wherein each route request message detects and collects latest bi-directional route metrics along its way traversing to the access point, and passes the end-to-end route metrics to the access point which is configured to compare the route metrics from different route request messages and respond to at least one of them based on a comparison of their respective route metrics.

7. The system of claim 1, wherein the route request metrics comprises at least one of the following: number of hops between the subscriber device and the access point, quality of links between the subscriber device and the access point, delay for a packet to travel between the subscriber device and the access point, available bandwidth on the links between the subscriber device and the access point, battery life of the hops, congestion at the hops.

8. A subscriber device for communicating with an access point device via a wireless network, the subscriber device comprising:
a controller, adapted to control the subscriber device to send along a first route to the access point a first route request message including a first route request identifier value, send along a second route to the access point a second route request message including the first route request identifier, receive route response messages from the access point that each include respective bi-directional route metrics, and select the second route for communication with the access point if the bi-directional route metrics for the second route are better than the bi-directional route metrics for the first route.

9. The subscriber device of claim 8, where each route request detects and collects latest bi-directional route metrics along its way traversing to the access point, and passes the end-to-end route metrics to the access point.

10. The subscriber device of claim 8, where the first route corresponds to a route to the access point that is currently being used by the subscriber device and the second route corresponds to a new route to the access point.

11. The subscriber device of claim 8, wherein the controller is further adapted to control the subscriber device to unicast the first and second route request messages to the access point.

12. The subscriber device of claim 8, wherein the subscriber device is further adapted to control the subscriber device to unicast multiple other route request messages to request multiple potential new routes to the access point, such that each route request message detects and collects latest bi-directional route metrics along its way traversing to the access point, and passes the end-to-end route metrics to the access point which is configured to compare the route metrics from different route request messages and respond to at least one of them based on a comparison of their respective route metrics.

13. The subscriber device of claim 8, wherein the route request metrics comprises at least one of the following: number of hops between the subscriber device and the access point, quality of links between the subscriber device and the access point, delay for a packet to travel between the subscriber device and the access point, available bandwidth on the links between the subscriber device and the access point, battery life of the hops, congestion at the hops.

14. A method for selecting a route from a subscriber device of a wireless network to an access point, the method comprising:
operating the access point to respond to receipt of a first route request message including a first route request identifier value by sending to a source of the first route request message a first route response message including bi-directional route metrics from the first route request message, and the access point is adapted to respond to a second route request message including the first route request identifier value by sending a second route response message including bi-directional route metrics from the subsequent route request message if the route metrics from the second route request message are better than the route metrics from the first route request message; and
operating the subscriber device to send along a first route to the access point the first route request message including the first route request identifier value, and the subscriber device is also configured to send the second route request message along a second route to the access point, the second route request including the route request identifier value that is the same as that included in the first route request.

15. The method of claim 14, where each route request detects and collects latest bi-directional route metrics along its way traversing to the access point, and passes the end-to-end route metrics to the access point;

16. The method of claim 14, further comprising:
operating the subscriber device to receive the first and second route response messages from the access point and, based on the bi-directional route metrics included in the route response messages, select the second route for communication with the access point if the route metrics for the second route are better than the route metrics for the first route.

17. The method of claim 14, where the first route corresponds to a route to the access point that is currently being used by the subscriber device and the second route corresponds to a new route to the access point.

18. The method of claim 14, further comprising:
operating the subscriber device to unicast the first and second route request messages as well as multiple other route request messages to request multiple potential new routes to the access point.

19. The method of claim 18, wherein each route request message detects and collects latest bi-directional route metrics along its way traversing to the access point, and passes the end-to-end route metrics to the access point which is configured to compare the route metrics from different route request messages and respond to at least one of them based on a comparison of their respective route metrics.

20. The method of claim 14, wherein the route request metrics comprises at least one of the following: number of hops between the subscriber device and the access point, quality of links between the subscriber device and the access point, delay for a packet to travel between the subscriber device and the access point, available bandwidth on the links between the subscriber device and the access point, battery life of the hops, congestion at the hops.
